(19) United States
(12) Patent Application Publication
(10) Pub. No.: US 2022/0076294 A1
(43) Pub. Date: Mar. 10, 2022

(54) PROCESSING APPARATUS, PROCESSING METHOD, AND NON-TRANSITORY STORAGE MEDIUM

(71) Applicant: NEC Corporation, Minato-ku, Tokyo (JP)

(72) Inventor: Nozomu FUJIWARA, Tokyo (JP)

(73) Assignee: NEC Corporation, Minato-ku, Tokyo (JP)

(21) Appl. No.: 17/299,499

(22) PCT Filed: Oct. 30, 2019
(86) PCT No.: PCT/JP2019/042566

§ 371 Date: Jun. 3, 2021

(30) Foreign Application Priority Data
Dec. 14, 2018 (JP) 2018-234425

(51) Int. Cl. G06Q 30/02; G06Q 30/06

(52) U.S. Cl. CPC G06Q 30/0255; G06Q 30/0641; G06Q 30/0629; G06Q 30/0269

(57) ABSTRACT

The present invention provides a processing apparatus (10) including a trial information acquisition unit (11) that acquires trial information including customer identification information and trial target identification information identifying a trial target tried by a customer identified by the customer identification information, an extraction unit (12) that extracts a product or a service of the same kind as the trial target from at least either purchase history information or trial history information being associated with the customer identification information, and a comparison screen output unit (13) that generates and outputs a comparison screen comparing the trial target with the product or the service extracted by the extraction unit (12).

### TECHNICAL FIELD

The present invention relates to a processing apparatus, a processing method, and a program.

### BACKGROUND ART

PTL 1 discloses a technique in which, when an output instruction is input to an article providing apparatus from a user terminal by near field communication, the article providing apparatus outputs a trial offer from an opening for receipt, and transmits product information of the trial offer to the user terminal.

PTL 2 discloses a technique in which, when a smartphone is put over an electronic tag placed on a display shelf, product information is transmitted to the smartphone from the electronic tag by near field communication, and the product information is displayed on a display of the smartphone.

### CITATION LIST

### Patent Literature

[PTL 1] Japanese Patent Application Publication No. 2018-81347
[PTL 2] Japanese Patent No. 6243570

### SUMMARY OF INVENTION

### Technical Problem

In a case of a technique described in PTL 1, a customer can evaluate a trial offer itself, but is not able to compare the trial offer with another product. Thus, information provided by the technique described in PTL 1 is insufficient in determining whether to actually purchase the trial offer. PTL 2 does not disclose a means for solving such a problem.

A problem to be solved by the present invention is to provide information about a comparison of a trial target tried by a customer with a product or a service suited to the customer.

### Solution to Problem

The present invention provides a processing apparatus including:
a trial information acquisition unit acquiring trial information including customer identification information and trial target identification information identifying a trial target tried by a customer identified by the customer identification information;
an extraction unit extracting a product or a service of the same kind as the trial target from at least either purchase history information or trial history information being associated with the customer identification information; and
a comparison screen output unit generating and outputting a comparison screen comparing the trial target with the product or the service extracted by the extraction unit.

The present invention provides a processing method executed by a computer, including:
a trial information acquisition step of acquiring trial information including customer identification information and trial target identification information identifying a trial target tried by a customer identified by the customer identification information;
an extraction step of extracting a product or a service of the same kind as the trial target from at least either purchase history information or trial history information being associated with the customer identification information; and
a comparison screen output step of generating and outputting a comparison screen comparing the trial target with the product or the service extracted by the extraction unit.

The present invention provides a program causing a computer to function as:
a trial information acquisition unit acquiring trial information including customer identification information and trial target identification information identifying a trial target tried by a customer identified by the customer identification information;
an extraction unit extracting a product or a service of the same kind as the trial target from at least either purchase history information or trial history information being associated with the customer identification information; and
a comparison screen output unit generating and outputting a comparison screen comparing the trial target with the product or the service extracted by the extraction unit.

### Advantageous Effects of Invention

The present invention can provide information about a comparison of a trial target tried by a customer with a product or a service suited to the customer.

### BRIEF DESCRIPTION OF DRAWINGS

The above-described object, the other objects, features, and advantages will become more apparent from a suitable example embodiment described below and the following accompanying drawings.

FIG. 1 is one example of a functional block diagram of an information provision system according to a present example embodiment.

FIG. 2 is a diagram illustrating one example of a hardware configuration of a processing apparatus according to the present example embodiment.

FIG. 3 is one example of a functional block diagram of the processing apparatus according to the present example embodiment.

FIG. 4 is a diagram illustrating one example of an application example of the information provision system according to the present example embodiment.

FIG. 5 is a diagram schematically illustrating one example of information processed by the processing apparatus according to the present example embodiment.

FIG. 6 is a diagram schematically illustrating one example of information processed by the processing apparatus according to the present example embodiment.

FIG. 7 is a diagram schematically illustrating one example of information processed by the processing apparatus according to the present example embodiment.

FIG. 8 is a diagram schematically illustrating one example of information processed by the processing apparatus according to the present example embodiment.

FIG. 9 is a flowchart illustrating one example of a flow of processing of the processing apparatus according to the present example embodiment.

FIG. 10 is a diagram schematically illustrating one example of information output by the processing apparatus according to the present example embodiment.

FIG. 11 is a diagram schematically illustrating one example of information output by the processing apparatus according to the present example embodiment.

FIG. 12 is one example of a functional block diagram of the processing apparatus according to the present example embodiment.

FIG. 13 is a flowchart illustrating one example of a flow of processing of the processing apparatus according to the present example embodiment.

FIG. 14 is one example of a functional block diagram of the processing apparatus according to the present example embodiment.

FIG. 15 is one example of a functional block diagram of the processing apparatus according to the present example embodiment.

FIG. 16 is a diagram schematically illustrating one example of information processed by the processing apparatus according to the present example embodiment.

FIG. 17 is a diagram schematically illustrating one example of information processed by the processing apparatus according to the present example embodiment.

FIG. 18 is a flowchart illustrating one example of a flow of processing of the processing apparatus according to the present example embodiment.

FIG. 19 is a sequence diagram illustrating one example of a flow of processing of the information provision system according to the present example embodiment.

FIG. 20 is a sequence diagram illustrating one example of a flow of processing of the information provision system according to the present example embodiment.

FIG. 21 is a flowchart illustrating one example of a flow of processing of the processing apparatus according to the present example embodiment.

FIG. 22 is a flowchart illustrating one example of a flow of processing of the processing apparatus according to the present example embodiment.

### EXAMPLE EMBODIMENT

### First Example Embodiment

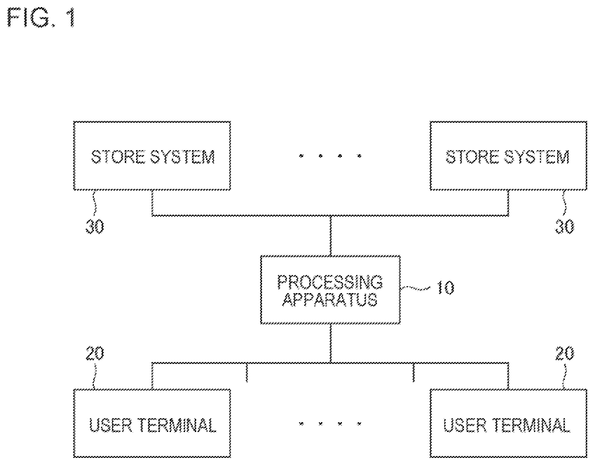

First, an overall vision and overview of an information provision system according to the present example embodiment are described. FIG. 1 illustrates one example of a functional block diagram of the information provision system. As illustrated, the information provision system includes a processing apparatus 10, a plurality of user terminals 20, and a plurality of store systems 30. The processing apparatus 10 and each of the user terminals 20 are configured communicably with each other via a network such as the Internet. Further, the processing apparatus 10 and each of the store systems 30 are configured communicably with each other via a network such as the Internet.

Each of the user terminals 20 is carried by each of a plurality of customers. A smartphone, a smartwatch, a tablet terminal, a mobile phone, a personal computer (PC), a portable game machine, or the like exemplifies the user terminal 20, but is not limited thereto.

Each of the store systems 30 is placed in each of a plurality of stores.

The processing apparatus 10 acquires trial information including customer identification information and trial target identification information from the user terminal 20 or store system 30. The trial target identification information is information identifying a trial target being a product or a service tried by a customer identified by the customer identification information. The processing apparatus 10 extracts a product or a service of the same kind as the trial target from at least either purchase history information or trial history information being associated with the customer identification information. Then, the processing apparatus 10 generates and outputs a comparison screen comparing the extracted product or the extracted service with the trial target. For example, the comparison screen is displayed on a display of the user terminal 20.

As above, the processing apparatus 10 according to the present example embodiment can generate and output a comparison screen comparing a product or a service tried by a customer with a product or a service of the same kind tried by the customer in the past. Further, the processing apparatus 10 according to the present example embodiment can generate and output a comparison screen comparing a product or a service tried by a customer with a product or a service of the same kind purchased by the customer in the past. In this way, the processing apparatus 10 according to the present example embodiment can provide information about a comparison of a trial target tried by a customer with a product or a service suited to the customer.

Next, a configuration of the processing apparatus 10 is described in detail. First, one example of a hardware configuration of the processing apparatus 10 is described. Each functional unit included in the processing apparatus 10 according to the present example embodiment is achieved by any combination of hardware and software, including a central processing unit (CPU) of any computer, a memory, a program loaded on the memory, a storage unit (that can store not only a program previously stored from a phase of shipping an apparatus, but also a program downloaded from a storage medium such as a compact disc (CD), a server on the Internet, and the like) such as a hard disk storing the program, and an interface for network connection. It is appreciated by a person skilled in the art that there are a variety of modification examples of an achievement method and an apparatus.

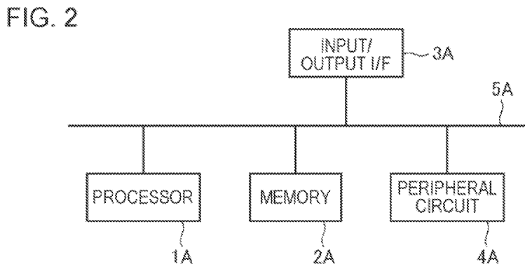

FIG. 2 is a block diagram illustrating a hardware configuration of the processing apparatus 10 according to the present example embodiment. As illustrated in FIG. 2, the processing apparatus 10 includes a processor 1A, a memory 2A, an input/output interface 3A, a peripheral circuit 4A, and a bus 5A. The peripheral circuit 4A includes various modules. The processing apparatus 10 may not include the peripheral circuit 4A. Note that, the processing apparatus 10 may be configured by a plurality of physically and/or logically separated apparatuses. In this case, each of the plurality of apparatuses can include the above-described hardware configuration.

The bus 5A is a data transmission path for the processor 1A, the memory 2A, the peripheral circuit 4A, and the input/output interface 3A to mutually transmit and receive data. The processor 1A is, for example, an arithmetic processing apparatus such as a CPU and a graphics processing unit (GPU). The memory 2A is a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, and the like. The output apparatus is, for example, a display, a speaker, a printer, a mailer, and the like. The processor 1A can give an instruction to each of modules, and perform an arithmetic operation, based on an arithmetic result of each of the modules.

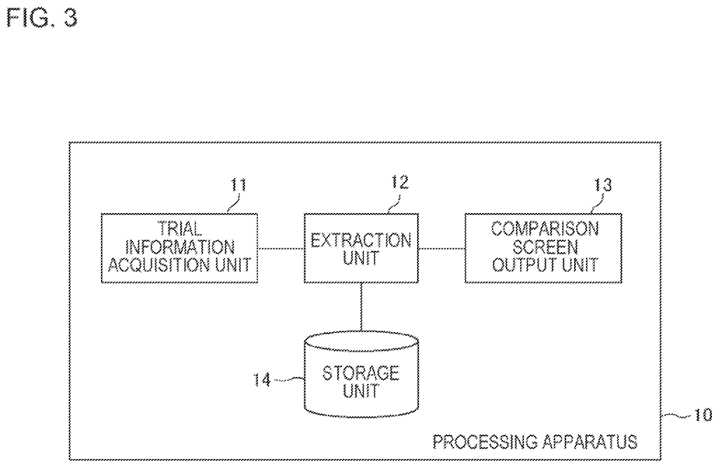

Next, one example of a functional configuration of the processing apparatus 10 is described. As illustrated in a functional block diagram of FIG. 3, the processing apparatus 10 includes a trial information acquisition unit 11, an extraction unit 12, a comparison screen output unit 13, and a storage unit 14. Note that, the processing apparatus 10 may not include the storage unit 14. In this case, the storage unit 14 is included in another external apparatus configured communicably with the processing apparatus 10.

The trial information acquisition unit 11 acquires trial information including customer identification information and trial target identification information.

A trial target is a product or a service provided for free or inexpensively for causing a customer to try. For example, a trial target may be a product such as an article of food, an article of daily use, sporting goods, clothes, or electric goods, may be a service such as an English conversation lesson or a tennis lesson, or may be anything else.

The trial target identification information is information identifying a plurality of trial targets. The trial target identification information included in the trial information is information indicating a trial target tried by a customer identified by the customer identification information included in the same trial information. The trial target identification information is, for example, a product name, a product code, a service name, a service code, or the like.

The trial information may include store identification information identifying a store where a trial target is tried, a date when the trial target is tried, and the like, in addition to the customer identification information and the trial target identification information.

Herein, one example of processing in which the trial information acquisition unit 11 acquires trial information is described. Note that, exemplification herein is only one example, and is not limited thereto.

Returning to FIG. 3, the storage unit 14 stores various kinds of pieces of information. In the present example embodiment, the storage unit 14 can store purchase history information, trial history information, product/service information, and the like.

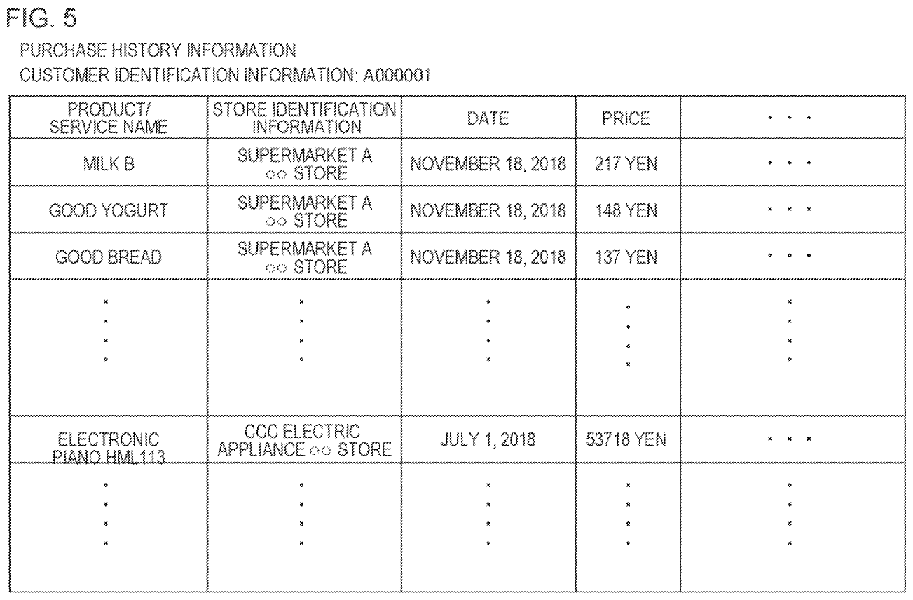

The purchase history information is information registering a purchase history of each customer in association with customer identification information. FIG. 5 schematically illustrates one example of the purchase history information. As illustrated, the purchase history information can include at least one of, for example, information identifying a purchased product or a purchased service (example: a product name, a service name, a product ID, or a service ID), store identification information identifying a store where the product the or service is purchased, a date when the product or the service is purchased, and a purchase price. The purchase history information may include other information. The purchase history information may include a purchase history at a plurality of stores.

A means by which the processing apparatus 10 acquires purchase history information and stores the acquired purchase history information in the storage unit 14 is not particularly limited. For example, customer identification information may be input to a register during payment at each store. Then, a store system may transmit, to the processing apparatus 10, a set of the customer identification information input to the register and a purchase history of a customer in the payment. Alternatively, each customer may register a purchase history on the processing apparatus 10 after logging in the processing apparatus 10 via a predetermined website or a predetermined application by use of the customer identification information of the customer.

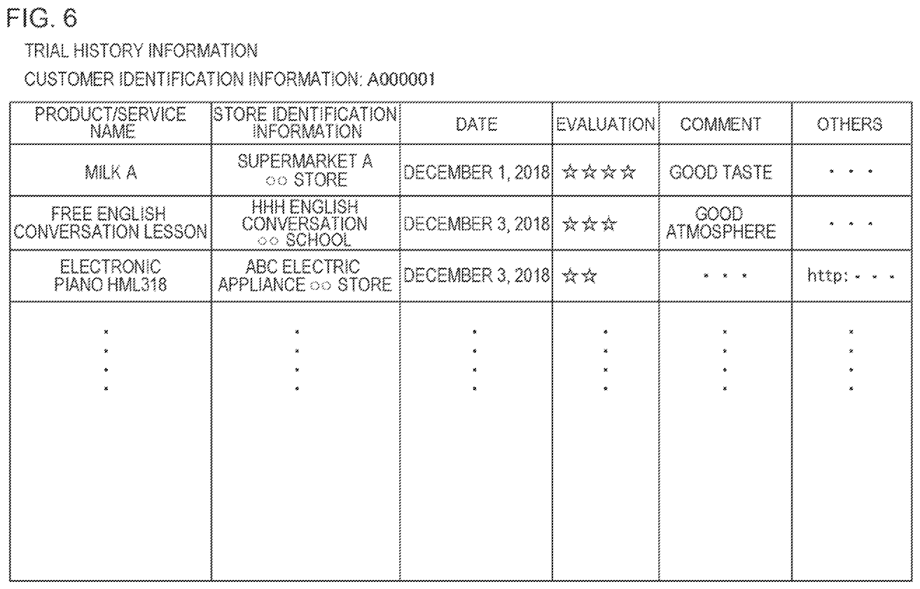

Next, trial history information is information in which a trial history of each customer is registered in association with customer identification information. FIG. 6 schematically illustrates one example of the trial history information. As illustrated, the purchase history information can include at least one of, for example, information identifying a tried product or a tried service (example: a product name, a service name, a product ID, or a service ID), store identification information identifying a store where the product or the service is tried, a date when the product or the service is tried, an evaluation by each customer, and a comment. The trial history information may include other information. Further, the trial history information may include a trial history at a plurality of stores.

The processing apparatus 10 can store trial information acquired by the trial information acquisition unit 11 in the storage unit 14 as trial history information. An evaluation by each customer and a comment can be registered on the processing apparatus 10 after each customer logs in the processing apparatus 10 via a predetermined website or a predetermined application by use of the customer identification information of the customer. An evaluation may be a five-grade evaluation as illustrated, or may be anything else.

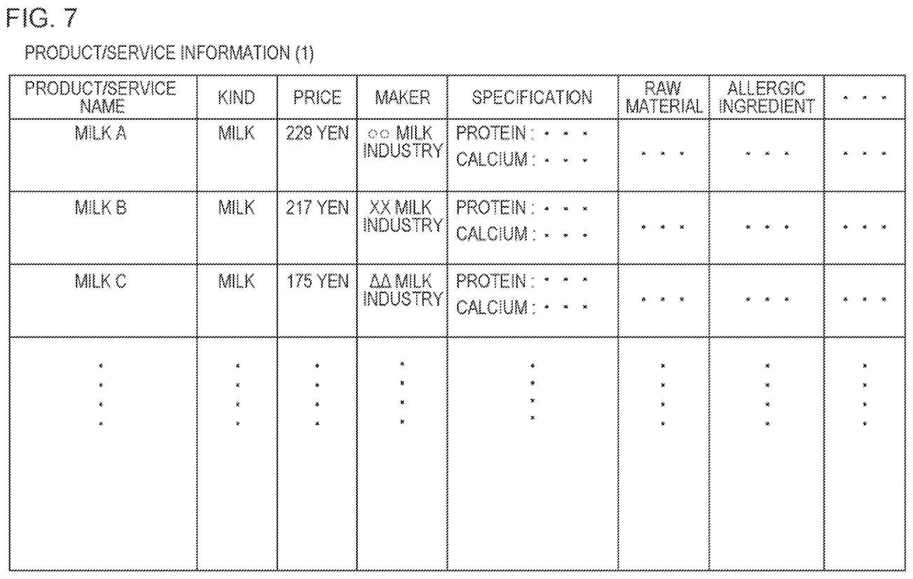

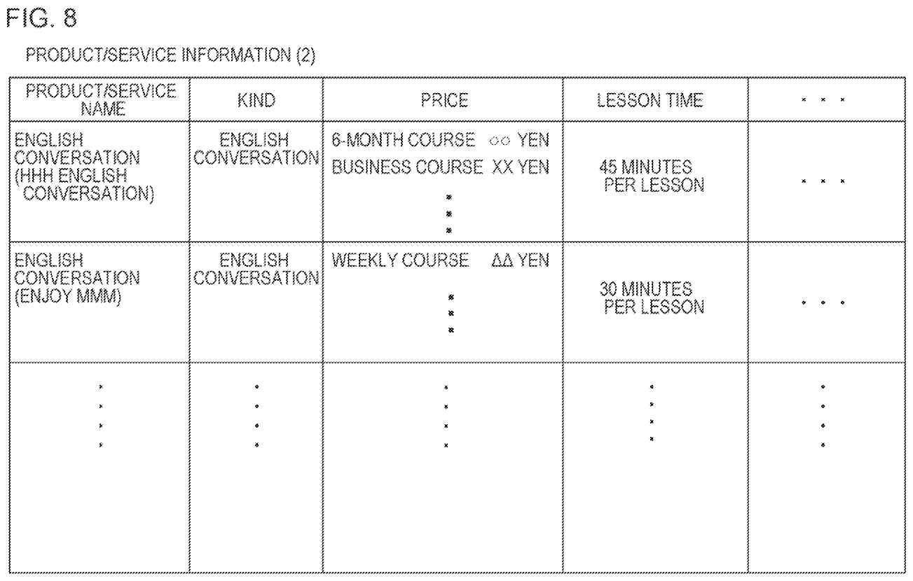

Next, the product/service information includes detailed information of a product or a service. FIGS. 7 and 8 schematically illustrate one example of the product/service information. As illustrated in the FIG. 7, the product/service information can include at least one of information identifying a product or a service, a kind of a product (which may hereinafter be referred to as a “product kind”), a price, a maker, a specification, a raw material, and a contained allergic ingredient. The product/service information may include other information. As illustrated in FIG. 8, the product/service information may include a service content such as a lesson time. Alternatively, although not illustrated, the product/service information may include a producer, a production date, word-of-mouth information registered by an unspecified number of customers, and the like.

Returning to FIG. 3, the extraction unit 12 extracts, from at least either purchase history information or trial history information, a product or a service of the same kind as the trial target identified by trial target identification information acquired by the trial information acquisition unit 11. The product or the service of the same kind is a product or a service of the same article group, a product or a service of the same article kind, a product or a service of the same article item, or the like. For example, the extraction unit 12 can extract, from a product or a service registered in purchase history information or trial history information, a product or a service for which the same value (including a character) as a trial target identified by trial target identification information is registered in a column of “kind” of product/service information illustrated in FIGS. 7 and 8, as a product or a service of the same kind as the trial target identified by the trial target identification information.

Returning to FIG. 3, the comparison screen output unit 13 generates and outputs a comparison screen comparing a trial target identified by trial target identification information acquired by the trial information acquisition unit 11 with the product or the service extracted by the extraction unit 12. The comparison screen output unit 13 can generate the above-described comparison screen by use of information indicated by at least one of the purchase history information as illustrated in the FIG. 5, the trial history information as illustrated in the FIG. 6, and the product/service information as illustrated in FIGS. 7 and 8. Details of the comparison screen are described in the following example embodiment.

For example, the comparison screen output unit 13 may provide a customer logging in a predetermined website via the user terminal 20, with a comparison screen on the website. Alternatively, the comparison screen output unit 13 may provide a customer starting a predetermined application via the user terminal 20, with a comparison screen on the application. Alternatively, an SNS account, an e-mail address, or the like may be previously registered in association with customer identification information. Then, the comparison screen output unit 13 may transmit a comparison screen to a destination that is an SNS account or an e-mail address being associated with the customer identification information acquired by the trial information acquisition unit 11.

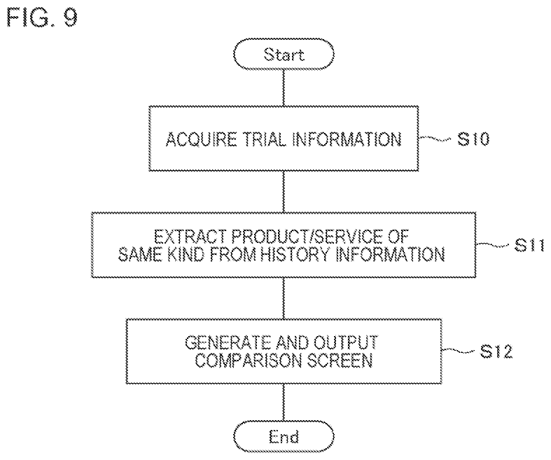

Next, one example of a flow of processing of the processing apparatus 10 according to the present example embodiment is described by use of a flowchart in FIG. 9.

First, the processing apparatus 10 acquires trial information including customer identification information and trial target identification information identifying a trial target tried by a customer identified by the customer identification information (S10).

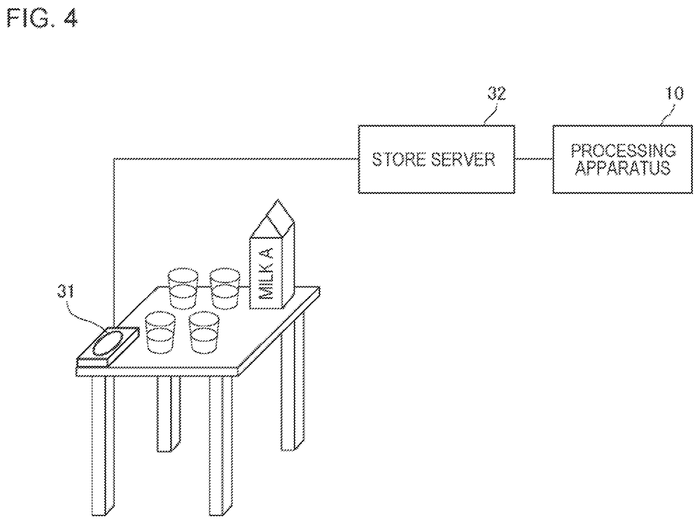

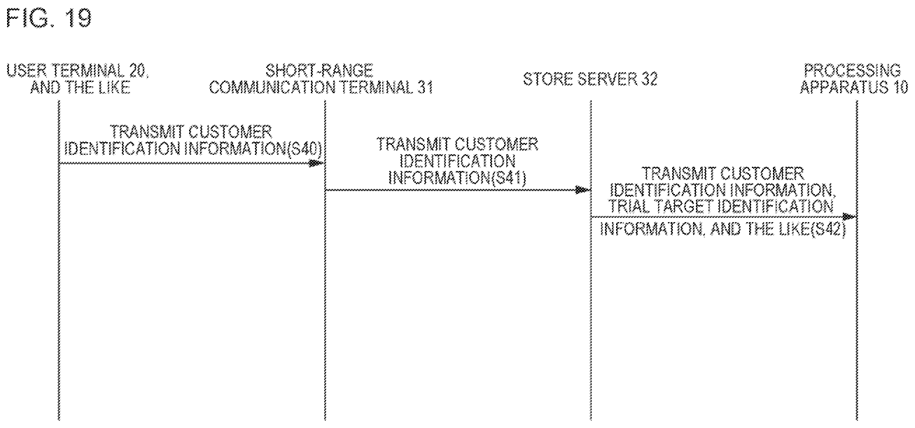

For example, as illustrated in FIG. 4, a trial corner is placed in a store. In the figure, a trial corner for tasting a milk A is placed. At the trial corner, a short-range communication terminal 31 (reader/writer) is placed. A customer tasting the milk A brings, close to the short-range communication terminal 31, electronic equipment such as the user terminal 20, an electronic card, or an electronic tag having a near field communication function and storing customer identification information of the customer, into a state of being communicable with each other. When the electronic equipment and the short-range communication terminal 31 are in a communicable state, the customer identification information is transmitted to the short-range communication terminal 31 from the electronic equipment, as illustrated in FIG. 19 (S40). The short-range communication terminal 31 transmits the received customer identification information to a store server 32 (S41). Then, the store server 32 transmits, to the processing apparatus 10, trial information including the customer identification information received from the short-range communication terminal 31, trial target identification information of a trial target (the milk A in a case of the illustrated example) provided at the trial corner where the short-range communication terminal 31 is placed, store identification information, a date, and the like (S42).

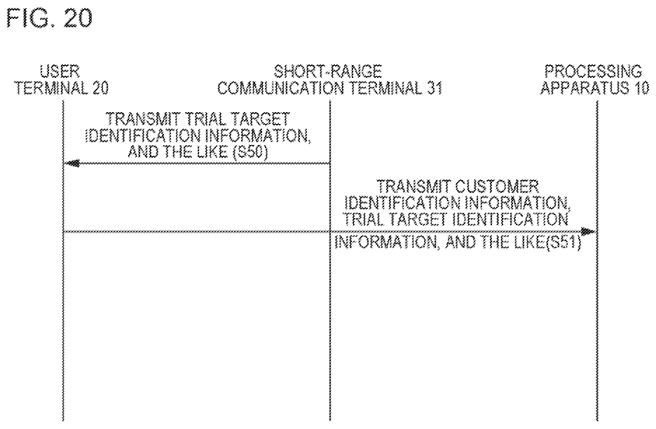

As another example, when the short-range communication terminal 31 and the user terminal 20 are in a state of being communicable with each other, the short-range communication terminal 31 may transmit, to the user terminal 20, trial target identification information, store identification information, a date, and the like, as illustrated in FIG. 20 (S50). Then, the user terminal 20 may transmit, to the processing apparatus 10, the received trial target identification information, and the trial information including the store identification information, the date, and customer identification information registered in the own apparatus (S51).

As another example, trial target identification information may be provided to a customer at a trial corner. For example, a paper medium on which trial target identification information is printed may be provided to a customer, a poster or the like on which trial target identification information is printed may be placed at a trial corner, trial target identification information may be orally conveyed to a customer from a clerk, or provision of trial target identification information may be achieved by other means. Then, the customer may register the trial target identification information, the store identification information, the date, and the like on the processing apparatus 10, after logging in the processing apparatus 10 via a predetermined website or a predetermined application by use of the customer identification information of the customer.

As another example, a clerk of a store providing, as a trial target, a service such as an English conversation trial lesson or a tennis trial lesson may elicit customer identification information from a customer. For example, a clerk may elicit customer identification information from a customer by use of a questionnaire or the like of a trial lesson. The clerk may input the customer identification information into a store system. Then, the store system may transmit the customer identification information, trial target identification information, store identification information, a date, and the like to the processing apparatus 10.

As another example, a customer receiving a service such as an English conversation trial lesson or a tennis trial lesson may be told trial target identification information, store identification information, and the like from a clerk of a store. For example, a paper medium on which trial target identification information or store identification information is printed may be provided to a customer. Then, the customer may register the trial target identification information, the store identification information, a date, and the like on the processing apparatus 10, after logging in the processing apparatus 10 via a predetermined website or a predetermined application by use of the customer identification information of the customer.

Returning to FIG. 9, after S10, the processing apparatus 10 extracts, from at least either purchase history information (refer to FIG. 5) or trial history information (refer to FIG. 6) being associated with customer identification information, a product or a service of the same kind as the trial target identified by trial target identification information acquired in S10 (S11). For example, the extraction unit 12 extracts, from a product or a service registered in purchase history information or trial history information, a product or a service for which the same value as a trial target identified by trial target identification information is registered in a column of “kind” of product/service information illustrated in FIGS. 7 and 8, as a product or a service of the same kind as the trial target identified by the trial target identification information.

Returning to FIG. 9, after S11, the processing apparatus 10 generates and outputs a comparison screen comparing a trial target identified by the trial target identification information acquired in S10 with the product or the service extracted in S11 (S12). For example, the processing apparatus 10 can generate the above-described comparison screen by use of information indicated by at least one of purchase history information (refer to FIG. 5), trial history information (refer to FIG. 6), and product/service information (refer to FIGS. 7 and 8) of a product or a service of the same kind as the trial target extracted in S11 and a product or a service determined by the trial information acquired in S10.

The processing apparatus 10 according to the present example embodiment described above can generate and output a comparison screen comparing a product or a service tried by a customer with a product or a service of the same kind tried by the customer in the past. There is a possibility that a product or a service tried by the customer this time or in the past is a product or a service in which the customer is interested, which the customer actually experiences and recognizes a content thereof, and which the customer considers possibly purchasing. It becomes easy for a customer to consider a target to purchase, by providing the customer with a screen comparing products or services tried by the customer with each other.

The processing apparatus 10 according to the present example embodiment can generate and output a comparison screen comparing a product or a service tried by a customer with a product or a service of the same kind purchased by the customer in the past. There is a possibility that a product or a service purchased by the customer in the past is a product owned by the customer, a product regularly purchased by the customer, or a service regularly purchased by the customer. It becomes easy for a customer to consider a target to purchase, by providing the customer with a screen comparing such a product or a service with a product or a service tried by the customer.

Thus, the processing apparatus 10 according to the present example embodiment can provide information about a comparison of a trial target tried by a customer with a product or a service suited to the customer.

### Second Example Embodiment

An information provision system according to a present example embodiment is different from that according to the first example embodiment in a point that a comparison screen generated by a processing apparatus 10 is embodied. Other components of the information provision system according to the present example embodiment are similar to those according to the first example embodiment.

A configuration of the processing apparatus 10 according to the present example embodiment is described below. One example of a hardware configuration of the processing apparatus 10 is similar to that according to the first example embodiment.

One example of a functional block diagram of the processing apparatus 10 according to the present example embodiment is illustrated by FIG. 3. As illustrated, the processing apparatus 10 includes a trial information acquisition unit 11, an extraction unit 12, a comparison screen output unit 13, and a storage unit 14. Note that, the processing apparatus 10 may not include the storage unit 14. In this case, the storage unit 14 is included in another external apparatus configured communicably with the processing apparatus 10. Configurations of the trial information acquisition unit 11, the extraction unit 12, and the storage unit 14 are similar to those according to the first example embodiment.

As described in the first example embodiment, the comparison screen output unit 13 generates and outputs a comparison screen. The comparison screen output unit 13 generates and outputs a comparison screen comparing at least one of a price, a maker, a specification, a raw material, an ingredient, a contained allergic ingredient, a producer, a production date, a service content, and word-of-mouth information. Alternatively, the comparison screen output unit 13 may display, on the comparison screen, a date when a product or a service is purchased or tried, store identification information identifying a store where the product or the service is purchased or tried, a purchase price or a sales price of the product or the service, and the like.

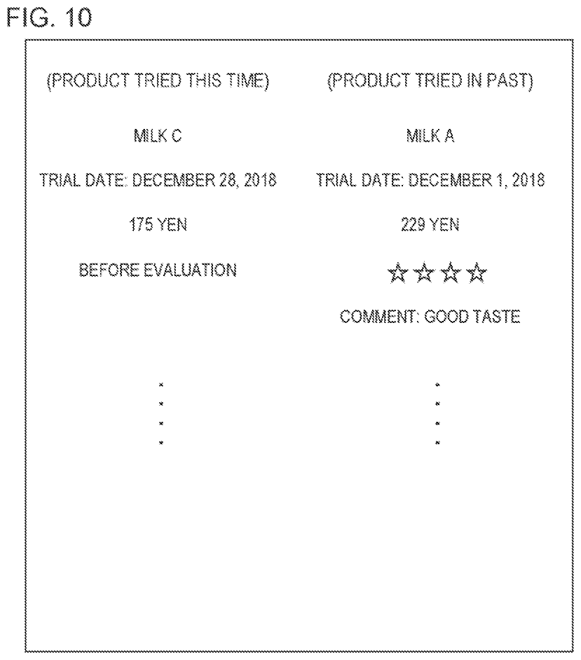

FIG. 10 schematically illustrates one example of a comparison screen generated by the comparison screen output unit 13. The illustrated comparison screen is a screen comparing a product (tried product) identified by trial target identification information acquired by the trial information acquisition unit 11 with a product of the same kind (product tried in the past) extracted by the extraction unit 12 from trial history information.

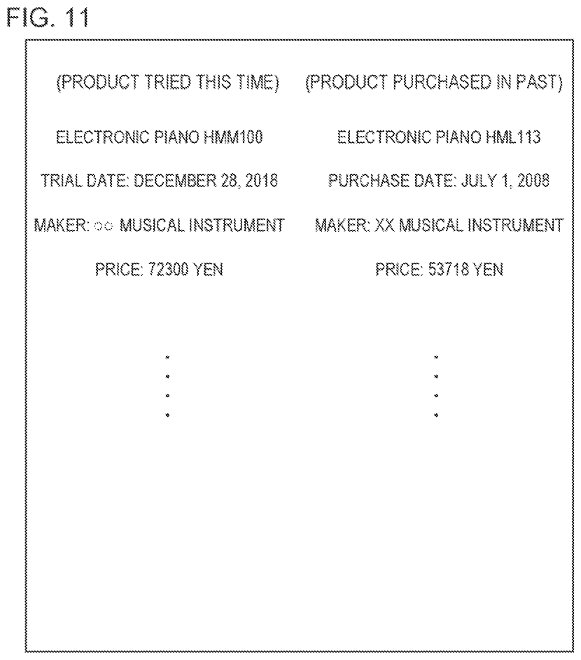

FIG. 11 schematically illustrates another example of a comparison screen generated by the comparison screen output unit 13. The illustrated comparison screen is a screen comparing a product (tried product) identified by trial target identification information acquired by the trial information acquisition unit 11 with a product of the same kind (product purchased in the past) extracted by the extraction unit 12 from purchase history information.

The processing apparatus 10 according to the present example embodiment described above can achieve an advantageous effect similar to that according to the first example embodiment. Further, with the processing apparatus 10 according to the present example embodiment, a comparison screen displaying a price, a maker, a specification, a raw material, an ingredient, a contained allergic ingredient, a producer, a production date, a service content, word-of-mouth information, a date when a product or a service is purchased or tried, store identification information identifying a store where the product or the service is purchased or tried, and the like can be provided. Since such useful information can be compared, it becomes easy for a customer to consider whether to purchase a tried product, and the like.

### Third Example Embodiment

An information provision system according to a present example embodiment is different from those according to the first and second example embodiments in a point of having a function of searching for trial history information under a predetermined search condition and outputting a search result. Other components of the information provision system according to the present example embodiment are similar to those according to the first or second example embodiment.

A configuration of a processing apparatus 10 according to the present example embodiment is described below. One example of a hardware configuration of the processing apparatus 10 is similar to those according to the first and second example embodiments.

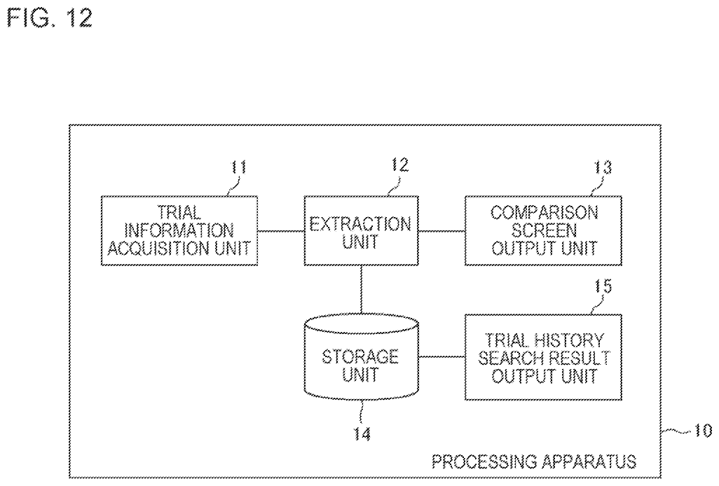

One example of a functional block diagram of the processing apparatus 10 according to the present example embodiment is illustrated by FIG. 12. As illustrated, the processing apparatus 10 includes a trial information acquisition unit 11, an extraction unit 12, a comparison screen output unit 13, a storage unit 14, and a trial history search result output unit 15. Note that, the processing apparatus 10 may not include the storage unit 14. In this case, the storage unit 14 is included in another external apparatus configured communicably with the processing apparatus 10. Configurations of the trial information acquisition unit 11, the extraction unit 12, the comparison screen output unit 13, and the storage unit 14 are similar to those according to the first or second example embodiment.

The trial history search result output unit 15 extracts a trial history coinciding with a predetermined search condition from trial history information, and outputs information indicating the extracted trial history.

A search condition may be able to be specified by each customer. As a search condition, at least one of items included in store identification information identifying a store where a trial is made, a date when a trial is made, an evaluation by a customer, a comment by a customer, and product/service information may be able to be specified. As one example of a search condition, “trial date: from Jan. 1, 2018 to Jun. 30, 2018, and evaluation: three or more stars”, “product kind: milk, evaluation: three or more stars, price: 200 yen or less”, or the like is exemplified, but is not limited thereto.

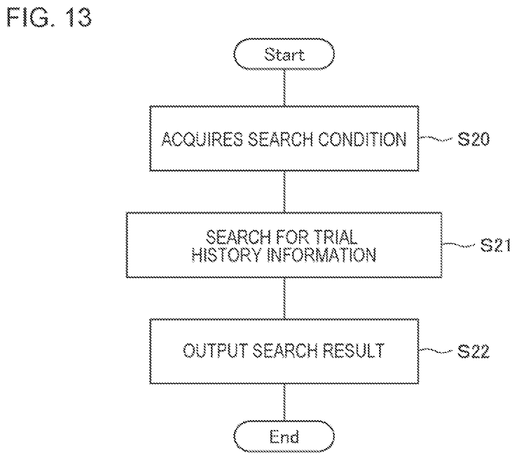

Next, one example of a flow of processing of the processing apparatus 10 according to the present example embodiment is described by use of a flowchart in FIG. 13.

First, a customer operates, for example, a user terminal 20, logs in the processing apparatus 10 via a predetermined website or a predetermined application by use of customer identification information of the customer, and then displays a search screen for searching for trial history information. Then, the customer performs, on the search screen, input for specifying a search condition, and an instruction input for executing a search. Accordingly, the user terminal 20 transmits the specified search condition to the processing apparatus 10.

The processing apparatus 10 acquires the search condition transmitted from the user terminal 20 (S20). For example, the processing apparatus 10 can acquire a search condition such as “trial date: from Jan. 1, 2018 to Jun. 30, 2018, and evaluation: three or more stars”, or “product kind: milk, evaluation: three or more stars, price: 200 yen or less”.

Then, the processing apparatus 10 extracts a trial history coinciding with the search condition from the trial history information (S21). For example, when the search condition is “trial date: from Jan. 1, 2018 to Jun. 30, 2018, and evaluation: three or more stars”, the processing apparatus 10 refers to trial history information as illustrated in FIG. 6, and searches for a trial history in which a value of a column of “date” is between “Jan. 1, 2018 to Jun. 30, 2018”, and a value of a column of “evaluation” is three or more stars. Alternatively, when the search condition is “product kind: milk, evaluation: three or more stars, price: 200 yen or less”, the processing apparatus 10 refers to the trial history information as illustrated in FIG. 6 and product/service information as illustrated in FIG. 7, and searches for a trial history in which a product with a value of a column of “evaluation” being three or more stars, a value of a column of “kind” of the product/service information being “milk”, and a value of a column of “price” being “200 yen or less” in the trial history information is registered in a column of “product/service name”.

Then, the processing apparatus 10 generates a search result screen including the extracted trial history, and returns the search result screen to the user terminal 20 (S22).

The processing apparatus 10 according to the present example embodiment described above can achieve an advantageous effect similar to that according to the first or second example embodiment. Further, with the processing apparatus 10 according to the present example embodiment, a customer becomes able to easily search for a desired trial history from trial history information. For example, a customer can narrow down purchase targets by performing a search under a predetermined condition after trying a plurality of trial targets.

### Fourth Example Embodiment

An information provision system according to a present example embodiment is different from those according to the first to third example embodiments in a point of having a function of registering, as trial history information, a storage destination address of electronic data generated when a product or a service is tried, and providing the trial history information to a customer. Other components of the information provision system according to the present example embodiment are similar to those according to the first, second, or third example embodiment.

A configuration of a processing apparatus 10 according to the present example embodiment is described below. One example of a hardware configuration of the processing apparatus 10 is similar to that according to the first to third example embodiments.

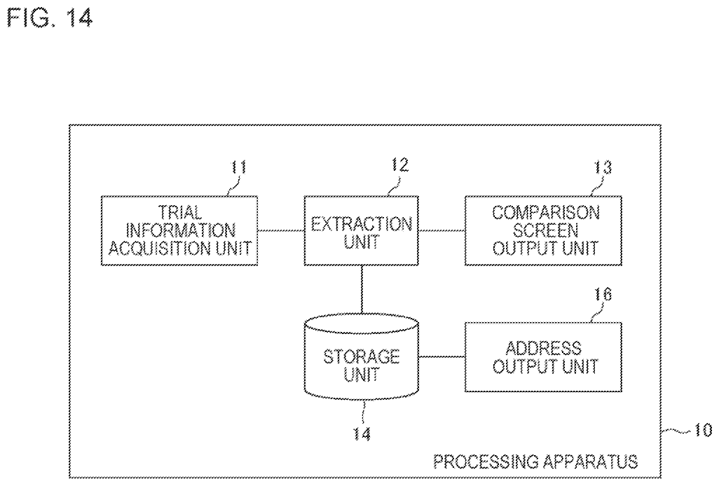

One example of a functional block diagram of the processing apparatus 10 according to the present example embodiment is illustrated by FIG. 14. As illustrated, the processing apparatus 10 includes a trial information acquisition unit 11, an extraction unit 12, a comparison screen output unit 13, a storage unit 14, and an address output unit 16. Note that, the processing apparatus 10 may further include a trial history search result output unit 15. Further, the processing apparatus 10 may not include the storage unit 14. In this case, the storage unit 14 is included in another external apparatus configured communicably with the processing apparatus 10. Configurations of the extraction unit 12, the comparison screen output unit 13, and the trial history search result output unit 15 are similar to those according to the first, second, or third example embodiment.

The trial information acquisition unit 11 acquires a storage destination address of electronic data generated when a product or a service is tried, and stores the acquired storage destination address in the storage unit 14 as trial history information. Electronic data to be stored may be electronic data generated by a trial target (example: an electronic instrument, a game, or the like), may be electronic data in which a customer trying a trial target is recorded by a camera, a voice recorder, or the like, or may be anything else. The electronic data are stored in a predetermined storage apparatus by any means. Then, the storage destination address of the electronic data is input to the processing apparatus 10 by any means. The storage destination address is, for example, a URL or the like. Other configurations of the trial information acquisition unit 11 and the storage unit 14 are similar to those according to the first, second, or third example embodiment.

The address output unit 16 outputs the storage destination address stored in the storage unit 14 as trial history information. The address output unit 16 may display the storage destination address of the electronic data on, for example, a comparison screen as illustrated in FIG. 10 or 11.

Alternatively, an SNS account, an e-mail address, or the like may be previously registered in association with customer identification information. The address output unit 16 may transmit the storage destination address of the electronic data to a destination that is an SNS account or an e-mail address being associated with customer identification information acquired by the trial information acquisition unit 11.

Alternatively, a customer may operate, for example, a user terminal 20, log in the processing apparatus 10 via a predetermined website or a predetermined application by use of the customer identification information of the customer, and then display trial history information. The address output unit 16 may display storage destination address information in association with each trial history on a screen displaying the trial history information.

The processing apparatus 10 according to the present example embodiment described above can achieve an advantageous effect similar to that according to the first, second, or third example embodiment. Further, with the processing apparatus 10 according to the present example embodiment, a customer can acquire, from trial history information, a storage destination address of electronic data generated when a trial target is tried. Each customer is capable of trying various products or services at various stores. Then, a plurality of pieces of electronic data being associated with various trial targets are capable of being generated when the trial targets are tried. When such a plurality of pieces of electronic data are separately managed, it becomes difficult for a customer to recognize what electronic data are stored, a storage destination of each piece of electronic data, and the like. The processing apparatus 10 according to the present example embodiment can collectively manage the storage destination of electronic data generated when a trial target is tried, and provide the storage destination to the customer as, for example, trial history information. Thus, management of electronic data generated when a trial target is tried becomes easy.

### Fifth Example Embodiment

An information provision system according to a present example embodiment is different from those according to the first to fourth example embodiments in a point of having a function of determining whether a product purchased by a certain customer is usable in combination with a product purchased by the customer in the past and outputting a determination result. Other components of the information provision system according to the present example embodiment are similar to those according to the first, second, third, or fourth example embodiment.

A configuration of a processing apparatus 10 according to the present example embodiment is described below. One example of a hardware configuration of the processing apparatus 10 is similar to that according to the first to fourth example embodiments.

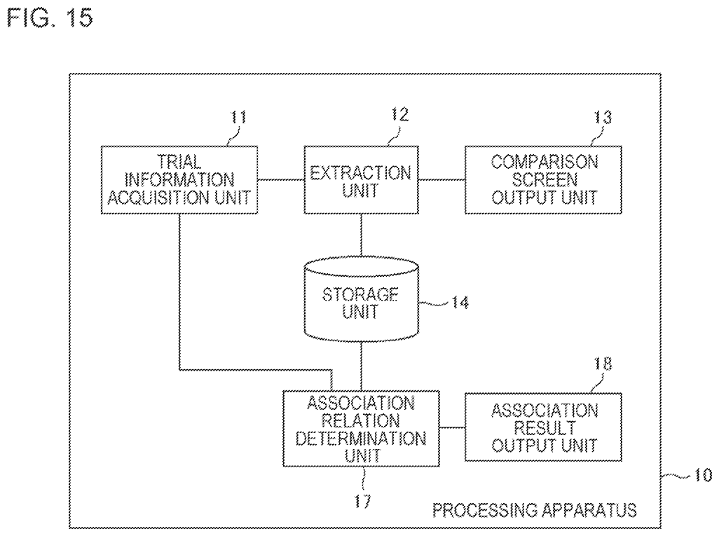

One example of a functional block diagram of the processing apparatus 10 according to the present example embodiment is illustrated by FIG. 15. As illustrated, the processing apparatus 10 includes a trial information acquisition unit 11, an extraction unit 12, a comparison screen output unit 13, a storage unit 14, an association relation determination unit 17, and an association result output unit 18. The processing apparatus 10 may further include at least either a trial history search result output unit 15 or an address output unit 16. Furthermore, the processing apparatus 10 may not include the storage unit 14. In this case, the storage unit 14 is included in another external apparatus configured communicably with the processing apparatus 10. Configurations of the trial information acquisition unit 11, the extraction unit 12, the comparison screen output unit 13, the trial history search result output unit 15, and the address output unit 16 are similar to those according to the first, second, third, or fourth example embodiment.

The storage unit 14 stores combination information and association information in addition to information described in the first to fourth example embodiments.

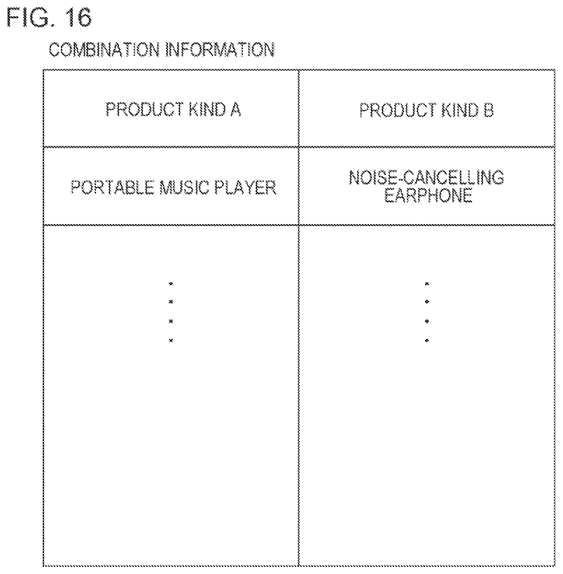

The combination information is information indicating a combination of product kinds used in combination with each other. For example, the combination information can indicate a combination of product kinds used in combination with each other, by use of “article group”, “article kind”, “article item”, and the like. FIG. 16 schematically illustrates one example of combination information. A combination of product kinds used in combination with each other is a combination of product kinds being at least “physically” or “electrically” connected to each other and used. As an example of a combination of product kinds used in combination with each other, a combination of a portable music player and a noise-cancelling earphone, a combination of a personal computer and a memory, a combination of a cleaner and a dust pack, and the like can be cited, but is not limited thereto.

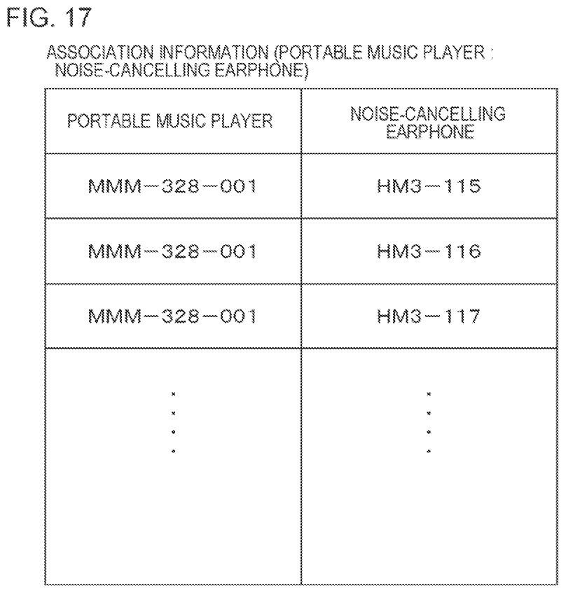

The association information is information indicating a combination of products being usable in combination with each other. For example, the association information can indicate a combination of products being usable in combination with each other, by use of a product name, a model number, and the like. A combination of products being usable in combination with each other means a combination of products that can be used without any problem when used in combination with each other. FIG. 17 schematically illustrates one example of the association information. The illustrated association information indicates a combination of a portable music player and a noise-cancelling earphone, and a combination of products (product names) being usable in combination with each other.

Returning to FIG. 15, the association relation determination unit 17 extracts, from purchase history information, a product of a kind used in combination with a trial target identified by trial target identification information acquired by the trial information acquisition unit 11, based on combination information. Then, the association relation determination unit 17 determines whether the extracted product is usable in combination with the trial target identified by the trial target identification information acquired by the trial information acquisition unit 11, based on association information.

The association result output unit 18 outputs a determination result of the association relation determination unit 17. The determination result is a determination result of whether the product extracted by the association relation determination unit 17 can be used in combination with the trial target identified by the trial target identification information acquired by the trial information acquisition unit 11. For example, a message such as “A tried product ‘noise-cancelling earphone HM3-115’ is an associated product of ‘portable music player MMM-328-001’ purchased at ABC electric appliance ◯◯ store on Feb. 17, 2018” may be output as a determination result.

The association result output unit 18 may display the determination result of the association relation determination unit 17 on, for example, a comparison screen as illustrated in FIG. 10 or 11.

Alternatively, an SNS account, an e-mail address, or the like may be previously registered in association with customer identification information. The association result output unit 18 may transmit the determination result of the association relation determination unit 17 to a destination that is an SNS account or an e-mail address being associated with customer identification information acquired by the trial information acquisition unit 11.

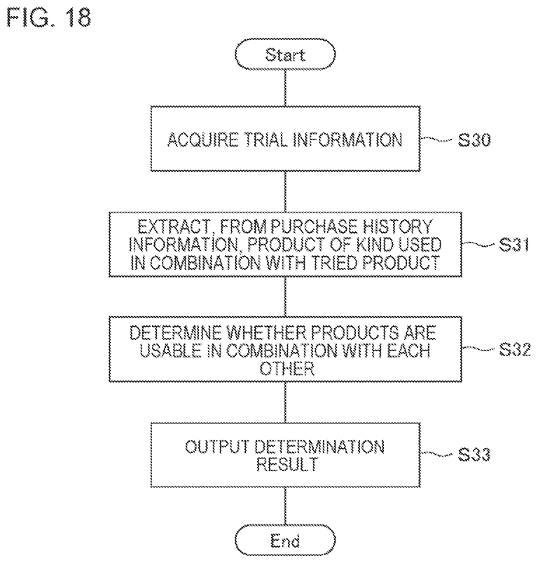

Next, one example of a flow of processing of the processing apparatus 10 according to the present example embodiment is described by use of a flowchart in FIG. 18.

First, the processing apparatus 10 acquires trial information including customer identification information and trial target identification information identifying a trial target tried by a customer identified by the customer identification information (S30).

Next, the processing apparatus 10 extracts, from purchase history information, a product of a kind used in combination with a trial target identified by trial target identification information acquired in S30, based on combination information (S31).

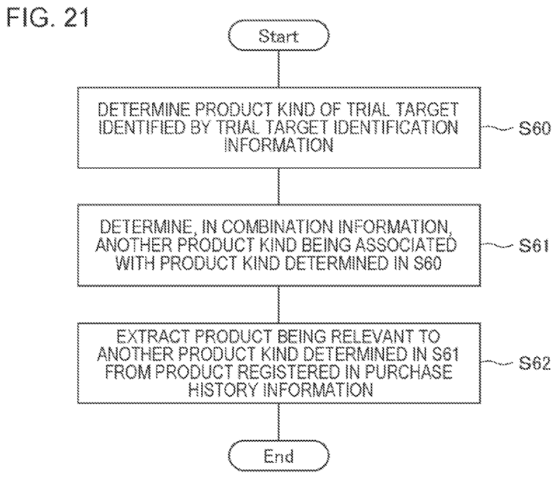

Herein, one example of a flow of processing in S31 is described by use of a flowchart in FIG. 21. For example, the processing apparatus 10 determines a product kind of a trial target identified by trial target identification information, by referring to product/service information illustrated in FIG. 7 (S60). Then, the processing apparatus 10 refers to combination information illustrated in FIG. 16, and determines another product kind being associated with the product kind determined in S60 (S61). Then, the processing apparatus 10 refers to purchase history information illustrated in FIG. 5 and the product/service information illustrated in FIG. 7, and extracts a product being relevant to the another product kind determined in S61, from a product registered in the purchase history information (S62).

Returning to FIG. 18, after S31, the processing apparatus 10 determines, based on association information, whether the product extracted in S31 can be used in combination with the trial target identified by the trial target identification information acquired in S30 (S32). Then, the processing apparatus 10 outputs a determination result in S32.

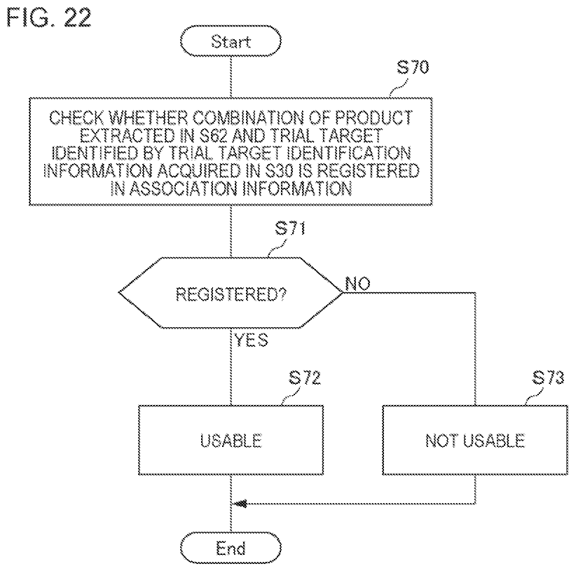

Herein, one example of a flow of processing of S32 is described by use of a flowchart in FIG. 22. For example, the processing apparatus 10 determines whether a combination of the product extracted in S62 and the trial target identified by the trial target identification information acquired in S30 is registered in association information illustrated in FIG. 17 (S70). When the combination is registered (Yes in S71), the processing apparatus 10 determines that the product and the trial target are usable in combination with each other (S72). On the other hand, when the combination is not registered (No in S71), the processing apparatus 10 determines that the product and the trial target are not usable in combination with each other (S73).

The processing apparatus 10 according to the present example embodiment described above can achieve an advantageous effect similar to that according to the first, second, third, or fourth example embodiment. Further, with the processing apparatus 10 according to the present example embodiment, a determination result of whether a product tried by a certain customer is usable in combination with a product purchased by the customer in the past (whether the product is a compatible product) can be provided to a customer. In this way, the processing apparatus 10 according to the present example embodiment can provide a customer with useful information in determining whether to actually purchase a trial offer.

### Modification Example

A modification example applicable to all the example embodiments is described. When a trial information acquisition unit 11 acquires new trial information, a processing apparatus 10 may issue and output a trial offer electronic receipt indicating a content of the trial information. Output of the trial offer electronic receipt may be transmission to a destination that is an SNS account or an e-mail address previously registered in association with customer identification information. Alternatively, when an electronic receipt is issued, the processing apparatus 10 may store the electronic receipt in a storage unit 14 in connection with customer identification information. The processing apparatus 10 may display the electronic receipt on a predetermined website or a predetermined application on a screen in response to user input on the website or the application.

Note that, a format of a trial offer electronic receipt may be the same as or different from a format of an electronic receipt indicating a purchase history. Further, a format of a trial offer electronic receipt may become different depending on a kind of a trial target, or may be common regardless of a kind of a trial target.

Further, a trial offer electronic receipt may include detailed information of a trial offer, information indicating a utilization method and the like of a trial offer, and the like. The pieces of information may be previously stored in the storage unit 14.

Further, a trial offer electronic receipt may include information (a URL or the like) of an online shop where the trial target can be purchased. The pieces of information may be previously stored in the storage unit 14.

Furthermore, allergy information indicating an allergic substance to be avoided by each customer may be previously registered in the storage unit 14. The processing apparatus 10 may determine, based on detailed information of a trial offer and the allergy information, whether the trial target includes the allergic substance to be avoided by the customer. Then, the processing apparatus 10 may output a result of the determination relating to allergy in such a way that the determination result is included in a trial offer electronic receipt and various kinds of screens described in the above-described example embodiments.

A supplementary note of an example of a reference embodiment is set forth below.

1. A processing apparatus including:
a trial information acquisition unit acquiring trial information including customer identification information and trial target identification information identifying a trial target tried by a customer identified by the customer identification information;
an extraction unit extracting a product or a service of the same kind as the trial target from at least either purchase history information or trial history information being associated with the customer identification information; and
a comparison screen output unit generating and outputting a comparison screen comparing the trial target with the product or the service extracted by the extraction unit.
   2. The processing apparatus according to supplementary note 1, wherein
the comparison screen output unit generates and outputs the comparison screen comparing at least one of a price, a maker, a specification, a raw material, an ingredient, an allergic ingredient, a producer, a production date, a service content, and word-of-mouth information.
   3. The processing apparatus according to supplementary note 1 or 2, wherein
the comparison screen output unit displays, on the comparison screen, at least either a purchase date of a product or a purchase date of a service extracted from the purchase history information.
   4. The processing apparatus according to any one of supplementary notes 1 to 3, further including
a trial history search result output unit extracting a trial history coinciding with a predetermined condition from the trial history information, and outputting information indicating the extracted trial history.
   5. The processing apparatus according to any one of supplementary notes 1 to 4, further including:
the trial history information including a storage destination address of electronic data generated when a product or a service is tried; and
an address output unit outputting the storage destination address.
   6. The processing apparatus according to any one of supplementary notes 1 to 5, further including:
an association relation determination unit extracting, from the trial history information, a kind of a product used in combination with the trial target, based on combination information indicating a combination of product kinds used in combination with each other and association information indicating a combination of products being usable in combination with each other, and determining whether the extracted product and the trial target are usable in combination with each other; and
an association result output unit outputting a determination result of the association relation determination unit.
   7. A processing method executed by a computer, including:
a trial information acquisition step of acquiring trial information including customer identification information and trial target identification information identifying a trial target tried by a customer identified by the customer identification information;
an extraction step of extracting a product or a service of the same kind as the trial target from at least either purchase history information or trial history information being associated with the customer identification information; and
a comparison screen output step of generating and outputting a comparison screen comparing the trial target with the product or the service extracted in the extraction step.
   8. A program causing a computer to function as:
a trial information acquisition unit acquiring trial information including customer identification information and trial target identification information identifying a trial target tried by a customer identified by the customer identification information;
an extraction unit extracting a product or a service of the same kind as the trial target from at least either purchase history information or trial history information being associated with the customer identification information; and
a comparison screen output unit generating and outputting a comparison screen comparing the trial target with a product or a service extracted by the extraction unit.

This application is based upon and claims the benefit of priority from Japanese Patent Application No. 2018-234425, filed on Dec. 14, 2018, the disclosure of which is incorporated herein in its entirety by reference.

What is claimed is:

1. A processing apparatus comprising:
at least one memory configured to store one or more instructions; and
at least one processor configured to execute the one or more instructions to:
acquire trial information including customer identification information and trial target identification information identifying a trial target tried by a customer identified by the customer identification information;
extract a product or a service of a same kind as the trial target from at least either purchase history information or trial history information being associated with the customer identification information; and
generate and output a comparison screen comparing the trial target with the extracted product or the service.

2. The processing apparatus according to claim 1,
wherein the processor is further configured to execute the one or more instructions to generate and output the comparison screen comparing at least one of a price, a maker, a specification, a raw material, an ingredient, an allergic ingredient, a producer, a production date, a service content, and word-of-mouth information.

3. The processing apparatus according to claim 1,
wherein the processor is further configured to execute the one or more instructions to display, on the comparison screen, at least either a purchase date of a product or a purchase date of a service extracted from the purchase history information.

4. The processing apparatus according to claim 1,
wherein the processor is further configured to execute the one or more instructions to extract a trial history coinciding with a predetermined condition from the trial history information, and output information indicating the extracted trial history.

5. The processing apparatus according to claim 1,
wherein the trial history information including a storage destination address of electronic data generated when a product or a service is tried; and
wherein the processor is further configured to execute the one or more instructions to output the storage destination address.

6. The processing apparatus according to claim 1,
wherein the processor is further configured to execute the one or more instructions to:
extract, from the trial history information, a kind of a product used in combination with the trial target, based on combination information indicating a combination of product kinds used in combination with each other and association information indicating a combination of products being usable in combination with each other, and determine whether the extracted product and the trial target are usable in combination with each other; and
output the determination result.

7. A processing method executed by a computer, comprising:
acquiring trial information including customer identification information and trial target identification information identifying a trial target tried by a customer identified by the customer identification information;
extracting a product or a service of a same kind as the trial target from at least either purchase history information or trial history information being associated with the customer identification information; and
generating and outputting a comparison screen comparing the trial target with the extracted product or the service.

8. A non-transitory storage medium storing a program causing a computer to:
acquire trial information including customer identification information and trial target identification information identifying a trial target tried by a customer identified by the customer identification information;
extract a product or a service of a same kind as the trial target from at least either purchase history information or trial history information being associated with the customer identification information; and
generate and output a comparison screen comparing the trial target with the extracted product or the service.
